(19) United States
(12) Patent Application Publication
(10) Pub. No.: US 2006/0080622 A1
(43) Pub. Date: Apr. 13, 2006

(54) Container metaphor for visualization of complex hierarchical data types

(75) Inventor: Anthony F. Stuart, Los Gatos, CA (US)

Correspondence Address: MIN, HSIEH & HACK LLP, 8270 GREENSBORO DRIVE, SUITE 630, MCLEAN, VA, 22102, US

(73) Assignee: INTERNATIONAL BUSINESS MACHINES CORPORATION

(21) Appl. No.: 10/961,218

(22) Filed: Oct. 12, 2004

(51) Int. Cl. G06F 17/00; G06F 3/00; G06F 17/21

(52) U.S. Cl. 715/853; 715/513; 715/764

(57) ABSTRACT

The present invention provides an efficient way of presenting hierarchical data or information based on a container metaphor. Nodes or information associated with the hierarchy are represented visually using a geometric shape, such as a rectangle, square, or circle. The hierarchical relationships of the data in the hierarchy can then be represented by displaying the shapes within one another to illustrate a container relationship or adjacent to each other to represent a different level of hierarchy. In addition, visual cues can be used to highlight the container relationship and the corresponding nature of the hierarchy. These cues can include, for example, shading the borders of the shape to give a three-dimensional illusion of depth, increasing the darkness of the background of each successively contained shape, and decreasing the size of the font of each successively contained shape.

### FIELD

The present invention relates to computer software and systems, and more specifically, to systems and methods for displaying hierarchical information.

### BACKGROUND

Modern computer operating systems often handle hierarchical data. Hierarchical data is data that is “classified according to various criteria into successive levels or layers.” Common examples of hierarchical data include the directories and files in a computer file system, or nested tags in hypertext markup language (HTML) or extensible markup language (XML) based scripting.

Hierarchical data is typically displayed and managed by conventional computer systems using a graphical interface that depicts a “tree” structure. For example, in the well-known application Windows Explorer by Microsoft Corporation, the hierarchical data or information is displayed using a panel on the left hand side that shows the tree, with each directory (or other parent object) represented by a folder. Folders can be expanded to show sub-folders that they contain. Sub-folders can themselves be expanded, and so on.

Unfortunately, conventional hierarchical tree wastes display space. As more branches of a tree are opened (or expanded), the tree expands vertically and quickly grows beyond the size of the display. When the tree expands beyond the size of the display, the user must periodically scroll up and down the tree or open and close branches of the tree in order to view that portion of the tree within the confines of the display. Therefore, conventional hierarchical trees create a vertically-oriented visual structure that does not take advantage of the horizontal layout of most common computer displays.

In addition, conventional hierarchical tree displays are not well suited for displaying large or complex data (such as long text strings, field/value pairs, or tables) for each node. This is because the deeper a node is in the hierarchy, the harder it is to find, and the harder it is to see its relationship to other nodes. That is, conventional hierarchical trees emphasize the hierarchical nature of the data as opposed to other relationships that may be present.

Accordingly, it would be desirable to provide methods and system that can efficiently display hierarchical data.

### SUMMARY

In accordance with embodiments consistent with the principles of the present invention, methods and apparatus are provided that display hierarchical data. A position of a first node of data in the hierarchy is determined. The first node of data can then be displayed as a geometric shape, wherein the geometric shape is configured based on the respective position of the first node of data within the hierarchy. Nodes that are subordinate to the first node are displayed as geometric shapes within the borders of the geometric shape. In addition, nodes that are superordinate to the first node are displayed as geometric shapes outside of the borders of the geometric shape.

Additional features of the invention will be set forth in part in the description which follows, and in part will be obvious from the description, or may be learned by practice of the invention. The features of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 illustrates a computer system that is consistent with the principles of the present invention;

FIG. 2 illustrates an example of a software architecture for a system that is consistent with the principles of the present invention;

FIG. 3 illustrates an exemplary display of hierarchical data or information that is consistent with embodiments of the present invention; and

FIG. 4 illustrates a process flow for displaying hierarchical data in accordance with embodiments of the present invention.

### DESCRIPTION OF THE EMBODIMENTS

One feature of the present invention provides a way to efficiently represent a hierarchy of data. In particular, portions of the hierarchy, such as nodes, categories, elements, etc., can be represented visually using a geometric shape, such as a rectangle, square, or circle. The hierarchical relationships between the various portions of data can then be represented using a “container metaphor” by positioning the shapes within one another to illustrate a container relationship or adjacent to each other for example, vertically or horizontally, to represent a different level of hierarchy. In addition, visual cues can be used to highlight the container relationship and the corresponding nature of the hierarchy. These cues can include, for example, shading the borders of the shape to give a three-dimensional illusion of depth, increasing the darkness of the background of each successively contained shape, and decreasing the size of the font of each successively contained shape.

Reference will now be made in detail to exemplary embodiments of the invention, which are illustrated in the accompanying drawings. Wherever possible, the same reference numbers will be used throughout the drawings to refer to the same or like parts.

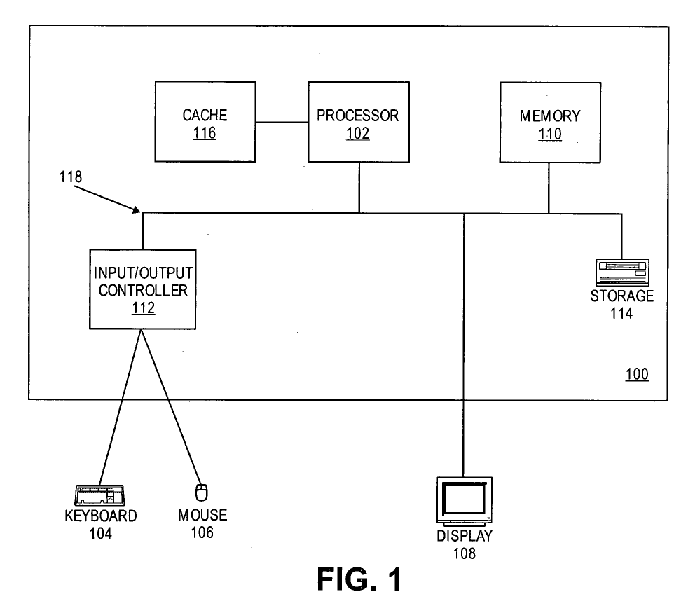

FIG. 1 illustrates a computer system 100 that is consistent with the principles of the present invention. Computer system 100 may be programmed with software to display data, such as hierarchical data, in accordance with the principles of the present invention. Examples of the components that may be included in computer system 100 will now be described.

As shown, a computer system 100 may include a central processor 102, a keyboard 104, a pointing device 106 (e.g., mouse, or the like), a display 108, a main memory 110, an input/output controller 112, and a storage device 114. Processor 102 may further include a cache memory 116 for storing frequently accessed information. Cache 116 may be an “on-chip” cache or external cache. System 100 may also be provided with additional input/output devices, such as a printer (not shown). The various components of the system 100 communicate through a system bus 118 or similar architecture.

Although FIG. 1 illustrates one example of a computer system, the principles of the present invention are applicable to other types of processors and systems. That is, the present invention may be applied to any type of processor or system that displays data, such as hierarchical data. Examples of such devices include personal computers, servers, handheld devices, and their known equivalents.

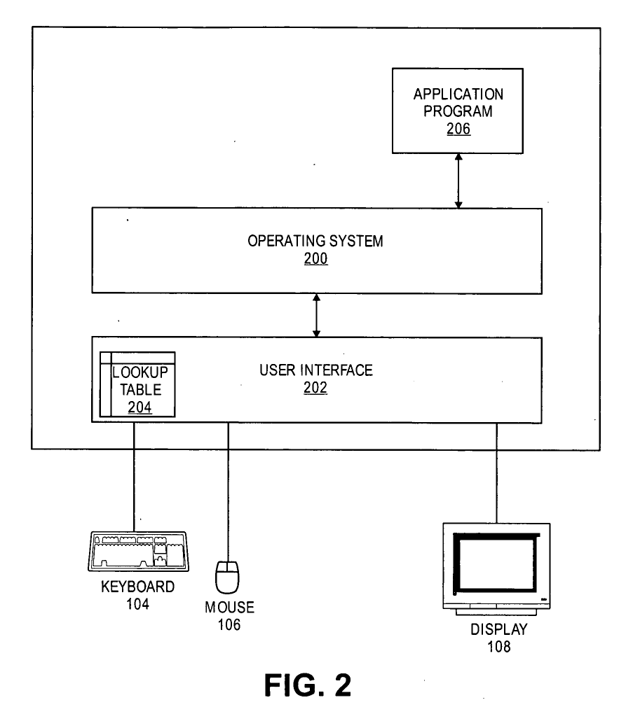

FIG. 2 illustrates an example of a software architecture for a system that is consistent with the principles of the present invention. As shown, the software architecture of computer system 100 may include an operating system (“OS”) 200, a user interface 202, a lookup table 204, and one or more application software programs 206. These components may be implemented as software, firmware, or some combination of both, which is stored in system memory 104 of system 100. The software components may be written in a variety of programming languages, such as C, C++, Java, etc.

OS 200 is an integrated collection of routines that service the sequencing and processing of programs and applications by computer system 100. OS 200 may provide many services for computer system 100, such as resource allocation, scheduling, input/output control, and data management. OS 200 may be predominantly software, but may also comprise partial or complete hardware implementations and firmware. Well known examples of operating systems that are consistent with the principles of the present invention include Mac OS by Apple Computer, Open VMS, GNU/Linux, AIX by IBM, Java and Sun Solaris by Sun Microsystems, Windows by Microsoft Corporation, Microsoft Windows CE, Windows NT, Windows 2000, and Windows XP.

Interface 202 provides a user interface for controlling the operation of computer system 100. Interface 202 may comprise an environment or program (such as the well known “desktop” of the Windows operating system) that controls or facilitates the display of on-screen data and options, usually in the form of icons and menus in response to user commands. Options provided by interface 202 may be selected by the user through the operation of hardware, such as mouse 106 and keyboard 104. These interfaces are well known in the art.

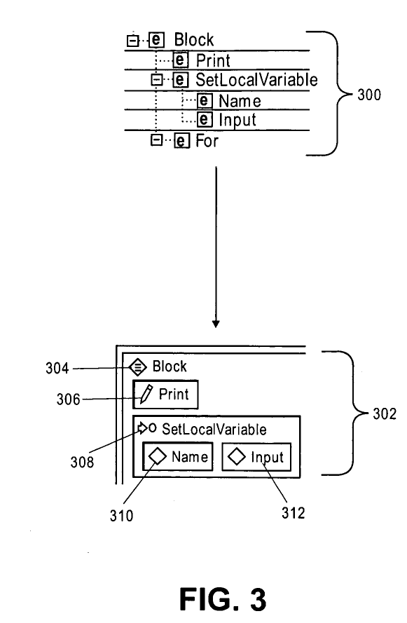

In some embodiments, interface 202 can be configured to graphically depict the relationship between the nodes or items of hierarchical data based on a visual container metaphor, such as boxes within boxes. For example, interface 202 may indicate the position of a node or element of hierarchical data by surrounding that data with distinguishable borders that can be “clicked” (e.g., based on input from mouse 106 or keyboard 104) to select the associated node or element of data. In some embodiments, interface 202 can be used to depict the natural container/contained relationship of data such as functions that operate (i.e., contain) various arguments. For example, interface 202 can be implemented as part of an XML editor. An exemplary display by interface 202 is illustrated in FIG. 3.

When displaying hierarchical data, interface 202 may perform a look-up to determine whether a box for the data should be laid out horizontally or vertically. Interface 202 can display the hierarchical data in a way that conserves the amount of space used on display 108, for example, by taking advantage of the horizontal dimensions of display 108.

In some embodiments, interface 202 may use multiple levels of nesting to display more complex types of data for each node, such as a table of values. In this way, low level data (e.g. “deep” nodes) can be displayed such that they are easily seen among the other visible elements shown on display 108. In addition, interface 202 can be configured to allow a wide variety of user control over the hierarchical data. For example, interface 202 can be configured to allow a user to tab (or back-tab) from node to node of hierarchical data, the ability to double-click on a node to edit it, and right button context sensitive help menus to add, remove, or change nodes.

Lookup table 204 stores various parameters about hierarchical data that is to be displayed by operating system 200. For example, in some embodiments, lookup table 204 can be configured to indicate XML tag to determine an item of hierarchical data should be laid out horizontally or vertically by operating system 200. Of course, one skilled in the art will recognize that other types of data structures or mechanisms can be displayed by embodiments of the present invention.

Additional application programs, such as application software 206, may be “loaded” (i.e., transferred from storage 110 into cache 112) for execution by the system 100. For example, application software 206 may comprise applications, such as an XML editor, word processor, spreadsheet, or database management system.

FIG. 3 illustrates an exemplary display of hierarchical data or information that is consistent with embodiments of the present invention. In some embodiments, data that is part of a hierarchy can be represented visually using an icon or geometric shape, such as a rectangle, square, or circle. Shapes representing various nodes of data can be positioned within one another to illustrate a container relationship and the hierarchy of data. In addition, visual cues can be used to highlight the container relationship and the corresponding nature of the hierarchy. These cues include, for example, shading the borders of the shape to give a three-dimensional illusion of depth, increasing the darkness of the background of each successively contained shape, and decreasing the size of the font of each successively contained shape.

In some embodiments, the shapes can be divided into two parts, a top part and a bottom part. The top part of a shape can be used to display the data, or content of the node, such as icon or text. The bottom part can be used to display the “contained” nodes of data and any siblings of that data. One example will now be described with reference to FIG. 3.

In order to assist in the illustration, FIG. 3 shows a data hierarchy 300 that is displayed in the form of container metaphor 302. For example, in FIG. 3, exemplary data for a print command used by an XML editor is shown. However, one skilled in the art will recognize that the principles of the present invention are applicable to any type of data.

In data hierarchy 300, the data can be represented internally using a binary tree. A binary tree is a well known software data structure in which each element of data is represented by a node. In addition to containing data, each node can also contain linkages to other nodes. Each node is linked to a “superordinate” node. Therefore, data hierarchy 300 can be conceptually represented based on the linkages to show the hierarchical relationships of the data contained in the nodes.

The superordinate node can also be called a parent node and the subordinate nodes can be called left-subordinate (or child) and right-subordinate (or sibling). Each subordinate node can, in turn, be the superordinate of another node to create trees of arbitrary complexity. Typically, one node in the tree has no parent node and is also know as the root node.

Container metaphor 302 can be displayed by interface 202 as the visual depiction of data hierarchy 300. As shown, root block 304 is the root node and is a superordinate of print node 306. Print node 306 is a left-subordinate of root block 304 and a superordinate of SetLocalVariable node 308. SetLocalVariable node 308 is a right-subordinate (i.e., a sibling) of print node 306, because it is at the same level in the hierarchy as print node 306 in this example. SetLocalVariable node 308 is a superordinate of name node 310 and input node 312. That is, name node 310 is a left-subordinate of SetLocalVariable node 308 and a superordinate of input node 312. Conversely, input node 312 is a right-subordinate of name node 310.

SetLocalVariable node 308 is also a superordinate of the “for” statement in data hierarchy 300 (not shown in container metaphor 302), which is a right-subordinate of SetLocalVariable node 308. In this example, print node 306, name node 310, and input node 312 do not have left-subordinates. However, one skilled in the art will recognize how these nodes could be shown with left-subordinates.

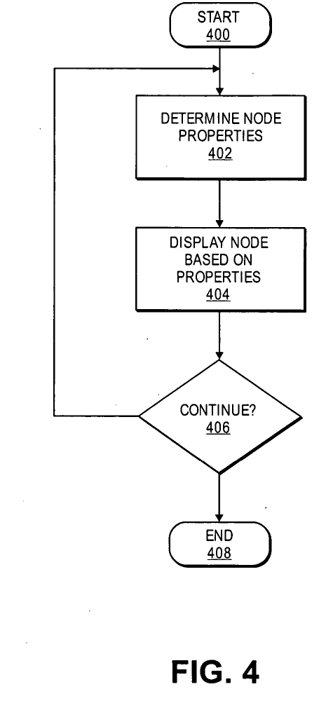

FIG. 4 illustrates a process flow for displaying hierarchical data in accordance with embodiments of the present invention. In stage 400, processing begins. For example, interface 202 may operate in conjunction with operating system 200 and/or application 206 to control the display of hierarchical data.

In stage 402, interface 202 determines the properties of each node of hierarchical data to be displayed. In some embodiments, interface 202 can perform a look-up on each node in lookup table 204 to determine how to lay out the various nodes. For example, if the look-up from lookup table 204 returns “vertical,” the contained nodes are laid out top to bottom by interface 202. If the look-up from lookup table 204 returns “horizontal,” the contained nodes are laid out left to right by interface 202. Other types of geometric arrangements, such as diagonals, can also be incorporated by embodiments of the present invention.

In stage 404, the nodes of data are displayed on display 108. For example, once interface 202 has determined the configuration of the nodes of data in container metaphor 302, interface 202 may then operate in conjunction with operating system 200 and display 108 to show the nodes of data to a user. For example, interface 202 can be implemented using Java to interface with any system, such as operating system 200, that supports a graphical user interface.

In stage 406, interface 202 determines whether it should continue with its processing. For example, interface 202 can determine whether processing should continue based on user commands, based on information from operating system 200 or application 206, or based on how much processing of the hierarchical data has been completed. If processing should repeat, then processing again flows back to stage 402 for the next node of hierarchical data. If processing is complete, then processing flows to stage 408 where processing ends.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of displaying hierarchical data, said method comprising:
determining a position of a first node of data in a hierarchy; and
displaying the first node of data as a geometric shape, wherein the geometric shape is configured based on the respective position of the first node of data within the hierarchy and wherein nodes that are subordinate to the first node are displayed as geometric shapes within borders of the geometric shape and nodes that are superordinate to the first node are displayed as geometric shapes outside of the borders of the geometric shape.

2. The method of claim 1, wherein determining a position of the first node comprises retrieving an extensible markup language tag associated with the node.

3. The method of claim 1, further comprising:
displaying at least one additional node that is at the same level in the hierarchy as another geometric shape that is positioned horizontally adjacent to the geometric shape that represents the first node.

4. The method of claim 1, further comprising:
displaying another geometric shape for an additional node that is immediately superordinate to the first node in a position that vertically adjacent to the geometric shape for the first node.

5. The method of claim 1, wherein the geometric shape of the first node is configured shaded borders to indicate the first node's position in the hierarchy.

6. The method of claim 1, wherein the geometric shape of the first node is divided into a plurality of parts to indicate properties of the data.

7. The method of claim 6, wherein at least one part of the geometric shape of the first node is configured to indicate an identifier for the first node.

8. The method of claim 6, wherein at least one part of the geometric shape of the first node is configured to indicate data that is contained within the first node.

9. An apparatus for displaying hierarchical data, comprising:
means for determining a position of a first node of data in a hierarchy; and
means for displaying the first node of data as a first geometric shape, wherein the first geometric shape is configured based on the respective position of the first node of data within the hierarchy and wherein nodes that are subordinate to the first node are displayed as second geometric shapes within the borders of the first geometric shape and nodes that are superordinate to the first node are displayed as third geometric shapes outside of the borders of the first geometric shape.

10. The apparatus of claim 9, wherein the means for determining a position of the first node is configured to retrieve an extensible markup language tag associated with the first node.

11. The apparatus of claim 9, further comprising:
means for displaying at least one additional node that is at the same level in the hierarchy as the first node as another geometric shape that is positioned horizontally adjacent to the first geometric shape that represents the first node.

12. The apparatus of claim 9, further comprising:
means for displaying another geometric shape for an additional node that is immediately superordinate to the first node in a position that vertically adjacent to the first geometric shape for the first node.

13. A device configured to display a hierarchy of data based on a container metaphor, said device comprising:
a processor; and
a memory that is coupled to the processor, wherein the memory includes program code that represents a first node of hierarchical data as a first geometric shape, wherein the first geometric shape is configured based on the respective position of the first node of data within the hierarchy and wherein nodes that are subordinate to the first node are represented as second geometric shapes within the borders of the first geometric shape and nodes that are superordinate to the first node are represented as third geometric shapes outside of the borders of the first geometric shape.

14. A computer program product embodied on a computer-readable medium having program code configured to cause a processor to display hierarchical information, said computer program product comprising:
program code for determining a position of a first node of information in a hierarchy; and
program code for displaying the first node of information as a first geometric shape, wherein the first geometric shape is configured based on the respective position of the first node within the hierarchy and wherein nodes that are subordinate to the first node are displayed as second geometric shapes within the borders of the first geometric shape and nodes that are superordinate to the first node are displayed as third geometric shapes outside of the borders of the first geometric shape.

15. The medium of claim 14, wherein the program code for determining a position of the first node comprises program code for retrieving an extensible markup language tag associated with the first node.

16. The medium of claim 14, further comprising:
program code for displaying at least one additional node that is at the same level in the hierarchy as the first node as another geometric shape that is positioned horizontally adjacent to the first geometric shape that represents the first node.

17. The medium of claim 14, further comprising:
program code for displaying another geometric shape for an additional node that is immediately superordinate to the first node in a position that vertically adjacent to the first geometric shape for the first node.

18. The medium of claim 14, wherein the program code for configuring the first geometric shape comprises program code for shading the borders of the first geometric shape to indicate the first node's position in the hierarchy.

19. The medium of claim 14, wherein the program code for configuring the first geometric shape comprises program code for dividing the geometric shape into a plurality of parts to indicate properties of the data.

20. The medium of claim 19, wherein program code for configuring the first geometric shape includes program code for configuring at least one part within the geometric shape to indicate data that is contained within the first node.
